(19) United States
(12) Patent Application Publication
(10) Pub. No.: US 2006/0116953 A1
(43) Pub. Date: Jun. 1, 2006

(54) Purchasing system and method

(76) Inventors: Peter Davin, Vastra Frolunda (SE); Rami Avidan, Goteborg (SE)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/248,060

(22) Filed: Oct. 12, 2005

Related U.S. Application Data
(60) Provisional application No. 60/617,049, filed on Oct. 12, 2004.

(51) Int. Cl. G06Q 40/00

(52) U.S. Cl. 705/39

(57) ABSTRACT

A network based system having a central server, at least one buyer computer and one merchant computer belonging to a reseller entity, at least one computer belonging to a reseller contact, the server receives information and saves information about the buyer, reseller and entities having permission to assign from agent entity to reseller entity reseller contact, the buyer computer programmed to allow purchasing product from merchant computer, merchant computer programmed to send information about the purchase from the buyer computer to the central server and financial transaction from the buyer to the reseller. Upon reception of a first transaction from the buyer to the reseller, the central server is programmed to allow transactions based on the first transaction to the reseller contact, and the server is arranged to store information about transactions and buyer, with respect to stored permissions, available to the reseller and the reseller contact on the server.

### CROSS-REFERENCE TO RELATED APPLICATIONS

This application claims the benefit of the filing date of U.S. Provisional Patent Application No. 60/617,049 filed Oct. 12, 2004, the disclosure of which is hereby incorporated herein by reference.

### TECHNICAL FIELD OF THE INVENTION

The present invention relates to an internet based trade handling system and method, especially a software ordering and purchasing system.

### BACKGROUND OF THE INVENTION

The recent development of e-commerce allows seamless delivery of goods and services. However, this also provides for a complex structure of trade, which can be difficult to handle.

### SUMMARY OF THE INVENTION

The present invention aims to simplify selling, ordering products and financial transaction in a computer network, especially evolving a number of operators such as agents, distributors and resellers.

More especially the present invention provides an interface for facilitating ordering and selling products.

According to a first aspect of the invention, a method of facilitating a purchase process using a computer network is provided. A number of computers are connected to the network, one of which is a central server unit. Each computer comprises memory means for storing information and instructions, microprocessors and communication arrangements. The method comprising the steps of: providing a sell structure comprising at least one agent entity, a distributor entity and a reseller entity, said entity being connected to said network, said entities having permission to assign from agent entity to reseller entity, allowing said reseller to sale a product to a costumer, providing said central server with information on said costumer and said sale, upon reception of a first finical transaction from said costumer to said reseller, allowing transactions based on said first transactions to said agent and/or distributor entities, storing information about transactions and costumer, based on permissions, available to all entities on said server.

According to a second aspect of the invention, a networks based sales system, comprising: a central server, at least one buyer computer, at lease one merchant computer belonging to a reseller entity, at lease one computer belonging to a reseller contact, wherein the server is programmed to receive information and save information about the buyer, reseller and entities having permission to assign from agent entity to reseller entity reseller contact, the buyer computer is programmed to allow purchasing a product from the merchant computer, the merchant computer being programmed to send information about the purchase from the buyer computer to the central server and financial transaction from the buyer to the reseller, upon reception of a first finical transaction from the buyer to the reseller, the central server being programmed to allow transactions based on the first transaction to the reseller contact, and the server being arranged to store information about transactions and buyer, with respect to stored permissions, available to the reseller and the reseller contact on the server.

### BRIEF DESCRIPTION OF THE DRAWINGS

In the following, the invention will be further described in a non-limiting way with reference to the accompanying drawings in which:

FIG. 1 schematically illustrates a system according to the present invention,

FIGS. 2-6 are block diagrams illustrating some exemplary functions in the system.

### DETAILED DESCRIPTION OF THE EMBODIMENTS

The present invention allows for a new trade structure involving agents, distributors and resellers and allows placing orders for buyers, administrating sale persons and buyers and handling the transactions and statistics Preferably, the invention is realized as a back office application at a producer site. Although, the invention is described referring to an example of selling software, it will be clear that the teachings of the invention can be used for providing any types of goods and services. The structure of the invention allows a producer to “outsource” the selling service to a selling structure outside the producer site but have total control over the entire sale chain and the financial transactions made there between. Preferably, all transactions are made to the producer but the selling chain is rewarded through a commission system.

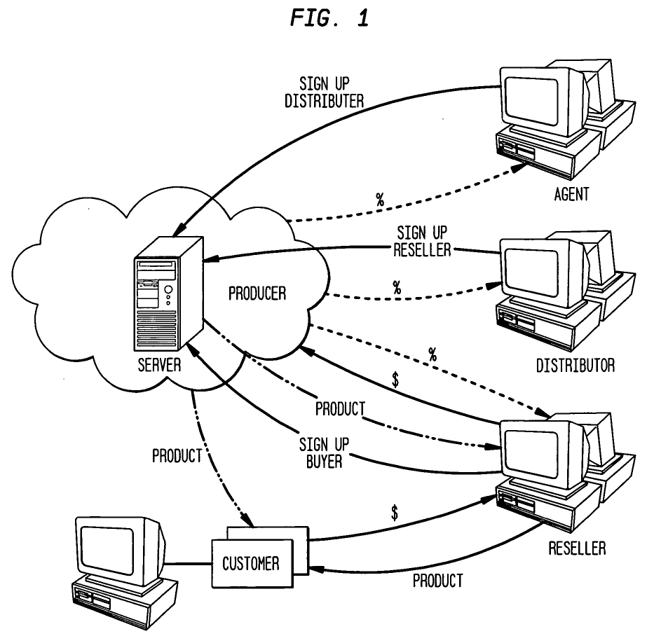

The diagram of FIG. 1 illustrates the structure of a system according to the present invention. The system comprises one or several central servers, preferably provided at a product or service provider site. The server can also be arranged at a service provider site providing the service to a producer. The server is in communication with one or several agents, distributors, and resellers. Obviously, one entity can act as all three.

An agent can be the representative of the producer. The distributor distributes the products through the reseller. The reseller sales the product to a costumer.

Each group: agent, distributor and reseller, comprises one or several administrators, sales managers and sales representatives. Table 1 illustrates an example what each administrator, sales manager and sales representative are allowed to do in the system.

TABLE 1

| | | SALES |
|---|---|---|
| ADMINISTRATOR | SALES MANAGER | REPRESENTATIVE |
| Reports | Marketing | Reseller Shop |
| Administrator | Send my customer | Buy for a new |
| can run a number | more info | customer |
| of reports | Product | Buy for an |
| regarding the | information | existing |
| sales | Sales Brochures | customer |
| Marketing | Logos and Banners | Marketing |
| Send customer | My Customer | Send my customer |
| more info | Allow entering | more info |
| Product | “My customers” | Product |
| information | Company Details | information |
| Sales Brochures | Company Details | Sales Brochures |
| Logos and | Administrator | Logos and |
| Banners | details | Banners |
| My Customer | Credit Balance | My Customer |
| Allow to enter | Financials | My customers |
| “My customers” | Add/Edit Sales | Company Details |
| Enter Company | Managers | Company Details |
| Details | Add/Edit Sales | Administrator |
| Company Details | Representatives | details |
| Administrator | Sales Group | Credit Balance |
| details | News and Special | Financials |
| Credit Balance | Offers | Add/Edit Sales |
| Financials | News | Managers |
| Add/Edit Sales | Special Offers | Add/Edit Sales |
| Managers | | Representatives |
| Add/Edit Sales | | Sales Group |
| Representatives | | News and Special |
| Sales Group | | Offers |
| News and Special | | News |
| Offers | | Special Offers |
| News | | |
| Special Offers | | |

“My” in the table concerns the costumers belonging to each group, which can be one or several agents, distributors, resellers or costumers.

Common for the system is that each agent signs up one or several distributors, each distributor signs up one or several resellers, and each reseller signs up one or several costumers and one or several costumer purchases products through one or several resellers. The reseller is the one who sells the product to an end costumer, and receives the financial settlement (lines indicated with $-sign). The transaction, entirely or partly, is forwarded to the producer. Based on the sold quantity (number of items or value), the agents and distributors, which are in the assignment chain of the reseller may receive a commission (lines indicated with %-sign) from producer. Other types of compensations may also occur. The product, for example a software package, a license key etc., can be delivered to the costumer directly from the producer server or through the reseller server. However, the title of the product, i.e. e.g. the ownership of the product is delivered through the reseller computer.

Followings are some examples how the back office can be used:

A representative enters into the back office and adds in a new reseller, including the administrator details.

Administrator is provided with the following information:

URL or an address to a Reseller section in the back office

Administrator Username

Administrator Password

The Reseller administrator can log in and add any sales managers who will be working under them and edit any information necessary.

A message informing that a sales manager has been added is generated. An email automated to the sales manager informing them that have been added to the system shop (welcoming them to use it).

The Administrator can also add sales representatives.

A message informing that a sales representative has been added is generated. An email automated to the sales representative informing them that have been added to the system shop (welcoming them to use it).

The Administrator can enter a sales group area to see the list of his sales managers and sales representatives.

The administrator can click on the sales representative to add or remove from under that sales manager.

All sales managers can see the sales representatives activities if they are in their team. They can not see any information concerning independent sales representatives or those under other sales managers.

There is a report section, where:

The administrator can generate different reports:

Order per customer,

Order per product,

Order per product aggregated (activated),

Order per Salesman (sales representative),

Customer List.

The system also comprises sales charts, when for example a reseller has been selling for one quarter.

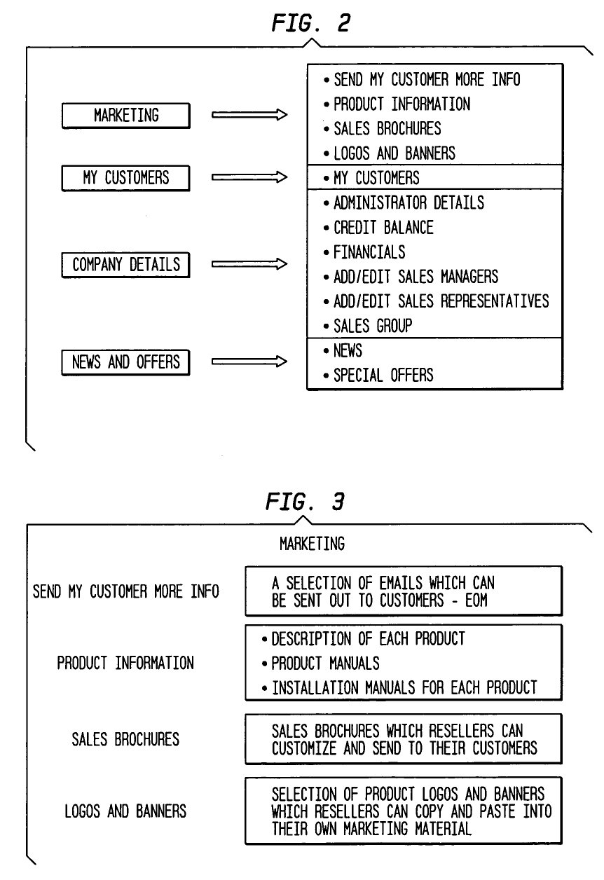

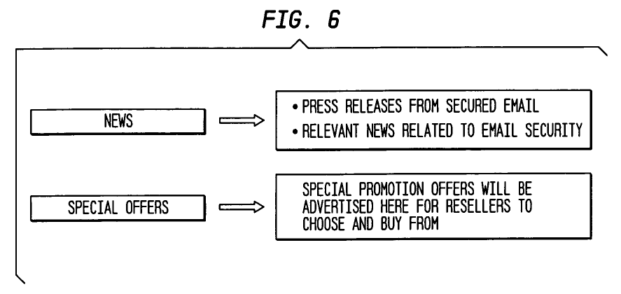

In the following some examples of the functions available for different groups are disclosed in conjunction with FIGS. 2-6:

The main functions are Marketing, My costumer, Company Details, News and Offers, see FIG. 2. These functions are given as examples and thus can be varied in various ways to adapt the system to a specific application.

Marketing, FIG. 3, include functions:

It is possible to send costumers more info,

Sales brochures can be provided in a certain format which the reseller can edit only certain areas and send to their customers,

Resellers can take the logos and banners they require for their own marketing material or to use where necessary,

Press releases in different languages which Resellers can email their contacts.

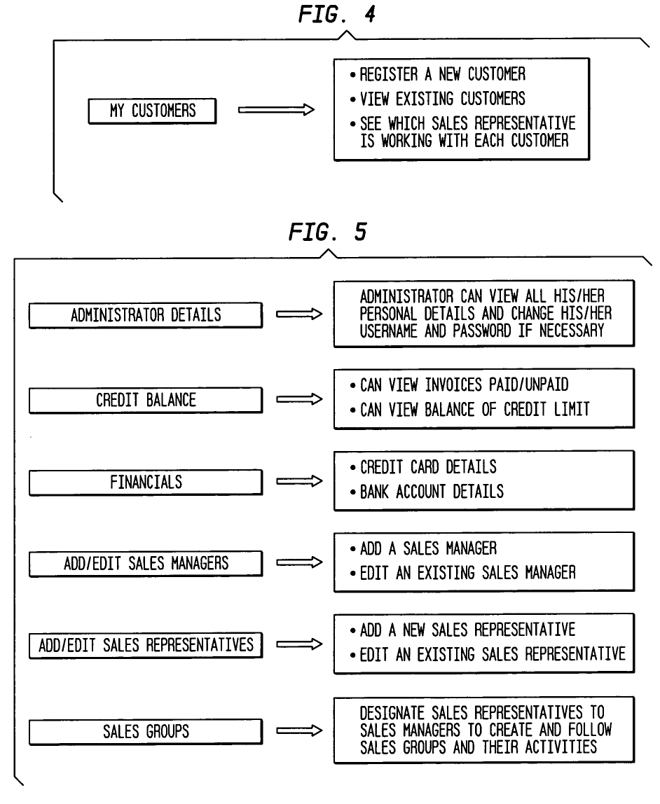

The Administrator can view all the customers they have, edit them or look at the statistics of products they have bought, quantity and date of last purchase. The administrator can update his own details, and also has the option of changing username and password. See FIG. 4.

Preferably, only a producer authorised member of staff can change the reseller administrator from one person to another.

For the financial part:

An administrator can view the amount of credit given to a company by the producer, the amount of credit left, ad date the total amount needs to be paid by The Administrator can add in a number of for example credit cards or other means of payment, which can be used to buy and also as a guarantee for the producer. Both of these cards have been verified.

The producer can provide special offers at different times which resellers can benefit from e.g. buy a number of products before a specified time/period and receive discount!

Although, it appears that the Sales Manager can receive all information that the Administrator sees this is not the case. The sales manager will not have access to all the reports the administrator can activate. The sales manager is only able to see the customers under him and his sales team (therefore also the customers of the sales representative under him). Minimum information can be given to the sales manager about costumer details. The sales manager can only see his own account details. The sales manger can only enter sales representatives for his team. There is no access given to other sales groups. No financial information is visible to the sales managers.

If an Administrator or Sales Manager is also involved in direct sales, they have to have a separate log in as a sales representative. The sales representative has even more limited information about the finance and customer. However, the in-logging as a sales representative allows purchasing.

The system allows the reseller to buy for a costumer, i.e. the costumer does not have to contact the producer to buy the product but receives it form the reseller.

Thus, the reseller can search for a customer or have a list of all Customers to view from.

Information can be provided on products already purchased and quantity, plus the date of the last sale to a customer.

The system according to the invention can be applied on a LAN (Local Area Network), WLAN (Wide LAN), through Internet or any other suitable network. Thus the server, and the computers connected to the server are provided with communication arrangement to communicate through the network, memory units for storing information and instructions sets, microprocessors for processing data and I/O means for MMI communications. Preferably, all data on all agents, distributors, resellers and costumers are stored centrally in the server and all information is available based on the permissions granted to one or several of the groups.

The invention is not limited to the shown embodiments but can be varied in a number of ways without departing from the scope of the appended claims and the arrangement and the method can be implemented in various ways depending on application, functional units, needs and requirements etc.

1. A method of facilitating a purchase process using a computer network, to which a number of computers are connected, one of which is a central server unit, each computer comprising storage units for storing information and instructions, microprocessors and communication arrangements, the method comprising the steps of:
providing a sell structure comprising at least one agent entity, a distributor entity and a reseller entity,
each of the entities being connected to the network,
the entities having permission to assign from the agent entity to the reseller entity,
allowing the reseller entity to sell a product to a customer,
providing the central server with information on the customer and the sale,
upon reception of a first financial transaction from the customer to the reseller entity, allowing transactions based on the first transactions to the agent and/or distributor entities, and
storing information about transactions and customer, based on permissions, available to all entities on the server.

2. A network based sales system, comprising:
a central server,
at least one buyer computer,
at least one merchant computer belonging to a reseller entity,
at least one computer belonging to a reseller contact,
wherein said server is programmed to receive information and save information about the buyer, reseller and entities having permission to assign from agent entity to reseller entity a reseller contact,
said at least one buyer computer having instructions to allow purchasing a product from said at least one merchant computer,
said at least one merchant computer having instructions to send information about said purchase from said at least one buyer computer to said central server and financial transaction from said buyer to said reseller,
upon reception of a first finical transaction from said buyer to said reseller, said central server having instructions to allow transactions based on said first transaction to said reseller contact, and
said server being arranged to store information about transactions and buyer, with respect to stored permissions, available to said reseller and said reseller contact on said server.

3. The system of claim 2, wherein at least one of said agent, distributor and reseller entities receive commission based on the transactions made.

4. The system of claim 2, wherein at buyer receives product via either said at least one merchant computer or reseller.

5. The system of claim 2, wherein said agent entity signs up a distributor and information about said sign up is stored in said central server.

6. The system of claim 2, wherein said distributor entity signs up a reseller and information about said sign up is stored in said central server.

7. The system of claim 2, wherein said reseller entity signs up a buyer and information about said sign up is stored in said central server.

8. The system of claim 2, wherein financial transactions are made between buyer, reseller and said central server for a purchased object.
